(19) United States
(12) Patent Application Publication
(10) Pub. No.: US 2010/0001507 A1
(43) Pub. Date: Jan. 7, 2010

(54) Boarding pass and identification holder

(76) Inventors: Mary T. Sblendorio, Hamden, CT (US); Marie G. Mentor, Hamden, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/459,576

(22) Filed: Jul. 2, 2009

Related U.S. Application Data
(60) Provisional application No. 61/077,822, filed on Jul. 2, 2008.

(51) Int. Cl. B42D 15/00; A45F 5/00

(52) U.S. Cl. 283/75; 224/600; 224/269

(57) ABSTRACT

Disclosed herein is a holder for carrying and displaying documents. The holder has two back to back transparent pockets and a third fold over pocket arranged in a manner that documents retained therein are easily accessible by the user and readily visible for inspection. The holder also enables marking on a document without the need to take it out. In addition, the holder has a retaining element that permits it to be attached to an object under the control of the user, for example, the user's clothing, belt, purse and carry-on, so that user's hands are free to carry other objects.

### CROSS REFERENCE TO RELATED APPLICATION

This application claims the benefit of U.S. Provisional Application Ser. No. 61/077,822, filed Jul. 2, 2008, the disclosure of which is incorporated herein by reference in its entirety.

### BACKGROUND

1. Field

Disclosed herein is a holder for carrying and displaying documents, which includes, but is not limited to, travel related documents such as boarding passes, passports and identification cards.

2. Description of the Related Art

Travelers often need to have their travel related documents readily available for inspection at multiple check points. More often, they have to fumble through their pockets, purse or backpack for different documents, at a time when they have to take care of their luggage, carried coats, or kids. On top of that, they may also be in a rush to catch an airplane. Some travelers choose to hold all the documents in their hands, however, it is not only inconvenient, but also presents the hazards of losing the documents or having them stolen. There is a need for a holder that not only carries all the travel related documents together, but also makes the documents readily visible for inspection.

Various types of transparent holders are known in the prior art. U.S. Pat. No. 3,216,135 discloses a badge holder that has two pockets or compartments, where one compartment is visible above the edge of the wearer's pocket. The holder is disclosed to be rigid and can't be folded.

U.S. Pat. No. 3,295,235 discloses a convention badge holder having superposed panels, connected in such a manner so as to provide upper and lower compartments. The holder can be folded to fit into a user's upper pocket.

U.S. Pat. No. 3,355,826 discloses a transparent badge holder having an upper and a lower divided compartments. The holder is adapted to be worn in the breast pocket of a coat with the lower compartment in the pocket and the upper compartment projecting thereabove to display an identification card.

All of the above disclosed holders require a pocket to use. In addition, these card holders are not designed for repeated replacement and removal of the card from the holder compartments. Further, only one side of the holder is able to be seen at any time. Thus, these holders are limited in their utilization.

Various improvements have been made to the holders. U.S. Pat. No. 3,657,834 discloses a badge holder of the pocket mounted type having two compartments, where the card contained therein can be removed and replaced. U.S. Pat. No. D 485,985 shows a ticket/pass and identification holder that is designed to be placed around the user's neck. U.S. Pat. No. 6,862,827 discloses a holder for displaying travel related documents including clear pockets where the travel related documents placed therein are allegedly to be readily visible. However, the holders disclosed in patent '985 and patent '827 can't be folded, and none of the disclosed holders enable marking on a document contained therein without the need to take the document out.

As such, it may be appreciated that there continues to be a need for a simple, convenient and cost effective boarding pass/identify card holder.

### BRIEF SUMMARY

Disclosed herein is a holder for holding and displaying documents such as a boarding pass, passport, driver's license, etc., where the documents are easily accessible by the user and readily visible for inspection. The holder also enables marking on a document contained therein without the need to take it out. The holder may be attached to an object under the control of the user, for example the user's clothing, belt, purse and carry-on, so that use is hands-free.

In an embodiment disclosed herein the holder has two transparent back to back pockets and a third fold-over pocket. However, the present invention is not limited to the specific embodiments illustrated herein, but may be accomplished in a variety of ways such as various sized pockets, multiple pockets, etc. The disclosed holder provides users with a simple, convenient and cost-effective way to display documents in a hands-free manner.

### BRIEF DESCRIPTION OF THE DRAWINGS

FIG. 1 is a front view of a first embodiment of the holder.

FIG. 2 is a back view of the first embodiment of the holder.

FIG. 3 is a side view of the first embodiment of the holder.

FIG. 4 is a front view of the first embodiment of the holder when the upper compartment is folded over.

FIG. 5 is a front view of a second embodiment of the holder.

FIG. 6 is a back view of the second embodiment of the holder.

FIG. 7 is a side view of the second embodiment of the holder.

FIG. 8 is a front view of the second embodiment of the holder when the upper compartment is folded over.

### DETAILED DESCRIPTION

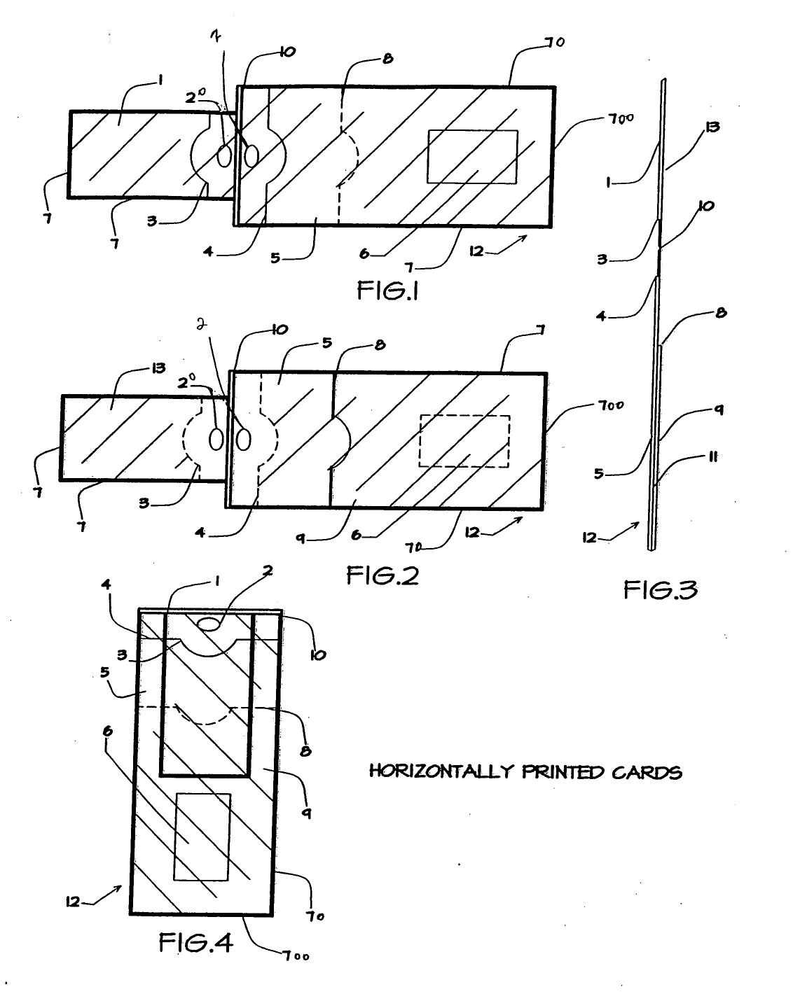

FIGS. 1-4 show a first embodiment of a holder 12 that includes an upper portion and a lower portion, where they are sealed together in a way so that the upper portion can be folded over to the lower portion. In one embodiment, the upper portion has a foldable pocket and the lower portion has a front pocket and a back pocket.

The lower portion of holder 12 includes a central sheet 11, a first sheet 5 and a second sheet 9, where sheet 5 is bonded to a front side of sheet 11 and sheet 9 is bonded to a back side of sheet 11 along sides 7, 70 and 700 of sheet 11. A fourth side 4 of sheet 5 in combination with central sheet 11 forms a front pocket with a slit-like opening effective to receive a document. Similarly, a fourth side 8 of sheet 9 in combination with central sheet 11 forms a back pocket with a slit-like opening effective to receive a document. In a preferred embodiment, central sheet 11 extends longitudinally beyond sheets 5 and 9.

The upper portion of holder 12 includes a third sheet 13 joined to the first end 10 of central sheet 11 and a fourth sheet 1 bonded to sheet 13 along three sides of sheet 13 whereby a fourth side 3 of sheet 1 in combination with sheet 13 forms a foldable pocket with a slit-like opening effective to receive a document. In a preferred embodiment, sheet 13 extends longitudinally beyond sheet 1.

It is appreciated that all the pockets can be of any size as long as they are effective to hold documents such as passports, drivers' licenses and boarding passes. It is also appreciated that slit-like openings of the pockets can each independently have a straight cut or a thumb cut. Each of the front, back or foldable pocket may independently have a lock mechanism to prevent the document contained therein from inadvertent displacement.

In one embodiment, the front pocket is of a rectangular shape having a length of from about 8 to about 9 inches and a width of from about 3.5 to about 4.5 inches. The front pocket can be effective to receive a boarding pass.

In another embodiment, the back pocket is of a rectangular shape having a length of from about 5 to about 7 inches and a width of from about 3.5 to about 4.5 inches. The back pocket can be effective to receive a passport.

In yet another embodiment, the foldable pocket is of a square or a rectangular shape having a length of from about 3.5 to about 4.5 inches and a width of from about 3.5 to about 4.5 inches. The foldable folder is effective to receive an ID such as driver's license.

The foldable pocket can have a different width from that of the front pocket and the back pocket. In one embodiment, the width of the foldable, front and back pockets are the same.

As illustrated in FIGS. 1, 2, and 3, there is an opening 6 in the front pocket to expose part of the document contained therein. It is appreciated that opening 6 may be of any size and shape as long as the pocket is effective to securely retain a document and at the same time, markings can be made on the exposed portion of the document. Although only opening 6 is shown in the drawings, it is appreciated that the back pocket and foldable pocket may also have openings if necessary. In one embodiment, the opening has a rectangular shape having a length of from about 5.5 to about 6.5 inches and a width of from about 1.5 to about 2.5 inches.

Holder 12 has a first aperture 2 below first end 10 of sheet 11 and a second aligned aperture 20 on sheet 13. Holder 12 also has a retaining element connected to apertures 2 and 20 to permit attachment of holder 12 to an object under the control of the user, for example, the user's clothing, belt, purse and carry-on. Holder 12 can also be placed around a user's neck. The retaining element can be of any kind of lanyard including retractable lanyard, a clip or any other conventional means.

Holder 12 can be made of vinyl or any other materials. Preferably sheets 1, 5, 9 and 11 are made from pliant transparent vinyl materials. Central sheet 11 is not limited to any particular material. In one embodiment, it is made from pliant vinyl material. The thickness of all the sheets are not particularly limited, but typically less than 5 mm, preferably less than 3 mm.

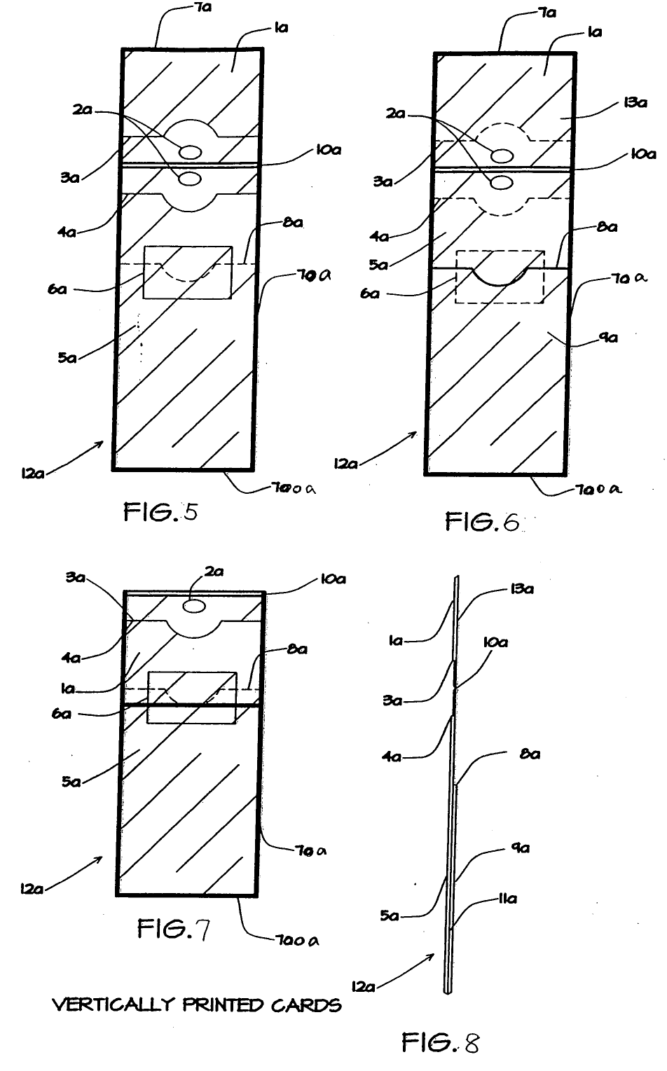

Holder 12 as illustrated in FIG. 1-4 is particularly suitable for holding horizontally printed cards. Another embodiment as illustrated in FIG. 5-8 is suitable for holding vertically printed cards. The parts referred to in FIG. 5-8 correspond to parts referred to by the same numerals in FIG. 1-4.

What is claimed is:

1. A holder for carrying and displaying documents comprising:
a central sheet having first and second opposing sides and opposing first and second ends;
a first sheet bonded to said first side of said central sheet along three sides of said first sheet, whereby a fourth side of said first sheet in combination with said central sheet forms a first pocket with a first slit-like opening effective to receive a first document;
a second sheet bonded to said second side of said central sheet along three sides of said first sheet, whereby a fourth side of said second sheet in combination with said central sheet forms a second pocket with a second slit-like opening effective to receive a second document;
a third sheet joined to said first end of said central sheet;
a fourth sheet bonded to said third sheet along three sides of said fourth sheet, whereby a fourth side of said third sheet forms a third pocket with a third slit-like opening effective to receive a third document.

2. The holder of claim 1 wherein said first, second and fourth sheets are made from substantially transparent vinyl materials.

3. The holder of claim 2 wherein at least one of said first or second pocket has an opening on said first or second sheet that enables marking on a document contained therein without the need to remove said document from said first or second pocket.

4. The holder of claim 3 wherein said central sheet has a first aperture adjacent to said first end and wherein said third sheet has a second aperture aligned with said first aperture when said third pocket is folded.

5. The holder of claim 4 further comprising a retaining element connected to said first and second apertures to permit attaching said holder to an object, wherein said object is under the control of the user of said holder.

6. The holder of claim 5 wherein said retaining element is a lanyard.

7. The holder of claim 6 wherein said lanyard is retractable.

8. The holder of claim 5 wherein said retaining element is a clip.

9. The holder of claim 2 wherein each of said first, second and third slit-like opening independently has a straight cut or a thumb cut.

10. The holder of claim 9 wherein at least one of said first, second and third pocket has a lock mechanism to prevent the document contained therein from inadvertent displacement.
